(19) United States
(12) Patent Application Publication
(10) Pub. No.: US 2006/0018630 A1
(43) Pub. Date: Jan. 26, 2006

(54) Retrospective television viewing

(75) Inventors: Michal Jacovi, Rakefet (IL); Shmuel Ur, Shorashim (IL)

Correspondence Address: LOUIS PAUL HERZBERG, 3 CLOVERDALE LANE, MONSEY, NY, 10952, US

(73) Assignee: International Business Machines Corporation, Armonk, NY (US)

(21) Appl. No.: 11/185,994

(22) Filed: Jul. 20, 2005

(30) Foreign Application Priority Data
Jul. 21, 2004 (EP) 0416266.5
Jul. 23, 2004 (GB) 0416448.9

(51) Int. Cl. H04N 5/76

(52) U.S. Cl. 386/83; 386/125

(57) ABSTRACT

The invention provides systems, apparatus and methods for recording a television broadcast, and a retrospective section of the record. These enable a television viewer to use a television control to select and store a retrospective section of a recorded television channel, while watching the channel. The retrospective section typically comprises a section of the channel that has just been watched by the viewer, so that an immediate replay of the retrospective section corresponds to an “instant” replay. An example method includes the steps of generating a record of the television broadcast, and operating a television remote control to select from the record, while viewing the television broadcast, a retrospective section of the record. The method further may include storing the retrospective section in the television remote control.

### FIELD OF THE INVENTION

The present invention relates generally to television broadcasting, and particularly to recording of a television broadcast.

### BACKGROUND OF THE INVENTION

Recording of a television broadcast, and use of the recording to view a replay of a section of the recording, are very well known in the art. In a simple form, a video recorder may be used to record the broadcast, and the recording replayed at some later time. A more versatile method, which may be used for a substantially “instant” replay, i.e., one which may be replayed immediately after a section of the broadcast has been viewed, uses a digital video recorder (DVR).

TiVo Inc., of Alviso, Calif., produces a DVR that enables instant replays to be displayed by a viewer watching a television broadcast. At the company's web site (www.tivo.com/1.0.asp) it is stated that TiVo offers a service which provides an instant replay.

UltimateTV is a service provided by Microsoft Corporation of Redmond, Wash. Details of the service may be found at www.ultimatetv.com. The service enables a viewer using a DVR to select instant replays in 7 second segments.

Digital Services North America, Inc., of Santa Clara, Calif., produces the “ReplayTV” DVR. The ReplayTV allows a viewer to select an instant replay of previously viewed live or recorded television. Details of the ReplayTV may be found at www.replay.com.

A press release dated Apr. 10, 2000, from ATI Technologies, Inc, of Toronto, Canada, may be found at www.ati.com/companyinfo/press/2000/4292.html. The press release states that a personal video recorder (PVR) produced by the company, based on a personal computer, allows a viewer to replay a sequence of a viewed program.

U.S. Pat. No. 5,345,430 to Moe, whose disclosure is incorporated herein by reference, describes a recording device and method for recovering a portion of a broadcast immediately after listening to or viewing it. The device incorporates a short term memory media to continuously record the last few minutes of a program, and control logic which upon command transfers material from the short term media to a long term storage within the device.

U.S. Pat. No. 5,721,951 to DorEl, whose disclosure is incorporated herein by reference, describes a home entertainment system. The system includes a capability for providing an instant replay of a viewed program in a multi-window display.

U.S. Patent Application 2002/0124262 to Basso et al., whose disclosure is incorporated herein by reference, describes a network-based video replay service. The service enables a first party to make their own personal recording, and store the recording. Once the recording has been made, the first party may mail a pointer to the recording to a second party with access to the service.

### SUMMARY OF THE INVENTION

In distinction, an aspect of the present invention provides systems, methods and apparatus for a television viewer to use a television control to select and store a retrospective section of a recorded television channel, while watching the channel. The retrospective section typically comprises a section of the channel that has just been watched by the viewer, so that an immediate replay of the retrospective section corresponds to an “instant” replay. Typically, the recorded section is stored in a digital video recorder (DVR) operated by, and local to, the viewer, and the television control is a remote control comprising a portable non-volatile memory.

In another aspect of the present invention, the retrospective section is stored by a retrospective viewing provider, such as a cable television company broadcasting the channel, rather than locally with the viewer. The viewer uses the control to send instructions to the provider for storage of the retrospective section.

In another aspect of the present invention, there is provided, according to an example embodiment, a method for recording a television broadcast, including: generating a record of the television broadcast; operating a television remote control to select from the record, while viewing the television broadcast, a retrospective section of the record; and storing the retrospective section in the television remote control.

In another aspect of the present invention, there is provided, according to another example embodiment, a method for recording a television broadcast, including: generating a record of the television broadcast at a retrospective viewing provider; operating a television remote control to communicate over a network with the provider so as to select from the record, while viewing the television broadcast on a television remote from the provider, a retrospective section of the record; and operating the television remote control to transfer from the provider to a receiver at least one of a pointer to the retrospective section and the retrospective section.

In another aspect of the present invention, there is provided, according to another example embodiment, a television remote control, including: a memory; a wireless communication interface, for communicating with television equipment; a user interface, which enables a viewer of a broadcast displayed by the television equipment to control functions of the remote control and of the television equipment via the communication interface; and a controller, which is adapted, under control of the viewer via the user interface, to select a retrospective section of the television broadcast, to receive the retrospective section from the television equipment over the wireless communication interface, and to store the retrospective section in the memory.

In another aspect of the present invention, there is provided, according to another example embodiment, a television apparatus for recording described below.

### BRIEF DESCRIPTION OF THE DRAWINGS

For a more complete understanding of the present invention and the advantages there of, reference is now made to the following description taken in conjunction with the accompanying drawings, in which:

FIG. 1 is a schematic illustration of a retrospective replay system, according to an embodiment of the present invention;

FIG. 2 is a flowchart showing steps of a process performed by a viewer in the system of FIG. 1, according to an embodiment of the present invention

FIG. 3 is a schematic illustration of an alternative retrospective replay system, according to an embodiment of the present invention; and

FIG. 4 is a schematic illustration of a further alternative retrospective replay system, according to an embodiment of the present invention.

### DESCRIPTION OF THE INVENTION

The present invention provides systems, methods and apparatus for a television viewer to use a television control to select and store a retrospective section of a recorded television channel, while watching the channel. The retrospective section typically comprises a section of the channel that has just been watched by the viewer, so that an immediate replay of the retrospective section corresponds to an “instant” replay.

Typically, the recorded section is stored in a digital video recorder (DVR) operated by, and local to, the viewer, and the television control is a remote control comprising a portable non-volatile memory. The remote control may be operated to select and transfer the retrospective section from the DVR to the portable memory, which may be removed from the remote control after storage of the retrospective section. Alternatively or additionally, the remote control is configured to relay the retrospective section from the DVR to an alternative portable non-volatile storage medium such as a compact disc. Storing the retrospective section in a non-volatile portable memory enables the television viewer to easily view the retrospective section at a later period, and/or to transfer the retrospective section to another viewer.

In an alternative embodiment of the present invention, the retrospective section is stored by a retrospective viewing provider, such as a cable television company broadcasting the channel, rather than locally with the viewer. The viewer uses the control to send instructions to the provider for storage of the retrospective section. The instructions typically include directions on the disposition of the retrospective section and/or the pointer to the section. The instructions may also include information as to which channel is to be used to generate the retrospective section, the information typically being supplied if the viewer is able to watch a plurality of channels simultaneously. In one embodiment, the provider may generate a telephone number for the section, on receipt of the instructions. Anyone calling the telephone number is able to display the retrospective section.

In an alternative embodiment of the present invention, there is provided, a method for recording a television broadcast, including the steps of: generating a record of the television broadcast; operating a television remote control to select from the record, while viewing the television broadcast, a retrospective section of the record; and storing the retrospective section in the television remote control. Typically, storing the retrospective section includes providing a non-volatile memory in the remote control, and the non-volatile memory may include a removable memory. Typically, generating the record includes storing the record in a digital video recorder (DVR), viewing the television broadcast includes viewing the broadcast on a television receiving the broadcast, and operating the television remote control includes communicating with the DVR and the television via the control.

In an alternative embodiment of the present invention, there is further provided, a method for recording a television broadcast, including the steps of: generating a record of the television broadcast at a retrospective viewing provider; operating a television remote control to communicate over a network with the provider so as to select from the record, while viewing the television broadcast on a television remote from the provider, a retrospective section of the record; and operating the television remote control to transfer from the provider to a receiver at least one of a pointer to the retrospective section and the retrospective section.

In an example embodiment, operating the television remote control includes implementing the remote control to communicate with the television via a first communication protocol, and implementing the television to communicate with the retrospective viewing provider over the network via a second communication protocol, different from the first protocol. The receiver typically includes at least one of a file storage system, a cellular telephone, and a data receiving system. The pointer typically includes at least one of a telephone number, a file address, and a uniform resource locator (URL). The television broadcast being viewed may be chosen from a plurality of broadcast channels, and operating the television remote control to communicate with the provider may include informing the provider of the broadcast channel corresponding to the television broadcast being viewed.

In an alternative embodiment of the present invention, there is further provided, a method for recording a television broadcast, including the steps of: generating a record of the television broadcast; and operating a television remote control to select from the record, while viewing the television broadcast, a retrospective section of the record and to relay, via a first memory comprised in the remote control, the retrospective section to a second memory separate from the remote control.

Typically, generating the record includes generating the record in a digital video recorder (DVR) which communicates with the remote control via a wireless communication protocol, the second memory includes a non-volatile memory which communicates with the remote control via the wireless communication protocol, and the first memory includes a volatile memory.

In an alternative embodiment of the present invention, there is further provided, a television remote control, including: a memory; a wireless communication interface, for communicating with television equipment; a user interface, which enables a viewer of a broadcast displayed by the television equipment to control functions of the remote control and of the television equipment via the communication interface; and a controller, which is adapted, under control of the viewer via the user interface, to select a retrospective section of the television broadcast, to receive the retrospective section from the television equipment over the wireless communication interface, and to store the retrospective section in the memory. In an example embodiment, the memory includes a non-volatile memory which is removable from the control.

In an alternative embodiment of the present invention, there is still further provided, a television apparatus, including: a television monitor which displays a television broadcast; a digital video recorder (DVR) which records the broadcast; a television remote control including a memory, the remote control communicating with the DVR and the monitor via a wireless communication interface, and being adapted to select a retrospective section of the television broadcast, to receive the retrospective section from the DVR over the wireless communication interface, and to store the retrospective section in the memory. Typically, the memory includes a non-volatile removable memory.

There is further provided, according to an embodiment of the present invention, a computer software product for recording a television broadcast, including a computer-readable medium having computer program instructions recorded therein, which instructions, when read by a computer, cause the computer to: generate a record of the television broadcast at a retrospective viewing provider, select, in response to an indication generated with a television control by a viewer of the broadcast displayed on a television and communicated over a network to the provider, a retrospective section of the record, and transfer, in response to the indication, at least one of a pointer to the retrospective section and the retrospective section from the provider to a receiver. Typically, the pointer includes at least one of a telephone number, a file address, and a uniform resource locator (URL), and the receiver includes at least one of a file storage system, a cellular telephone, and a data receiving system.

In an alternative embodiment of the present invention, there is further provided, a method for recording a television broadcast, including: the steps of: generating a record of the television broadcast in television equipment; and operating a television remote control to select from the record, while viewing the television broadcast on the television equipment, a retrospective section of the record and to convey at least one of the retrospective section and a pointer to the retrospective section to a receiver separate from the remote control and the television equipment.

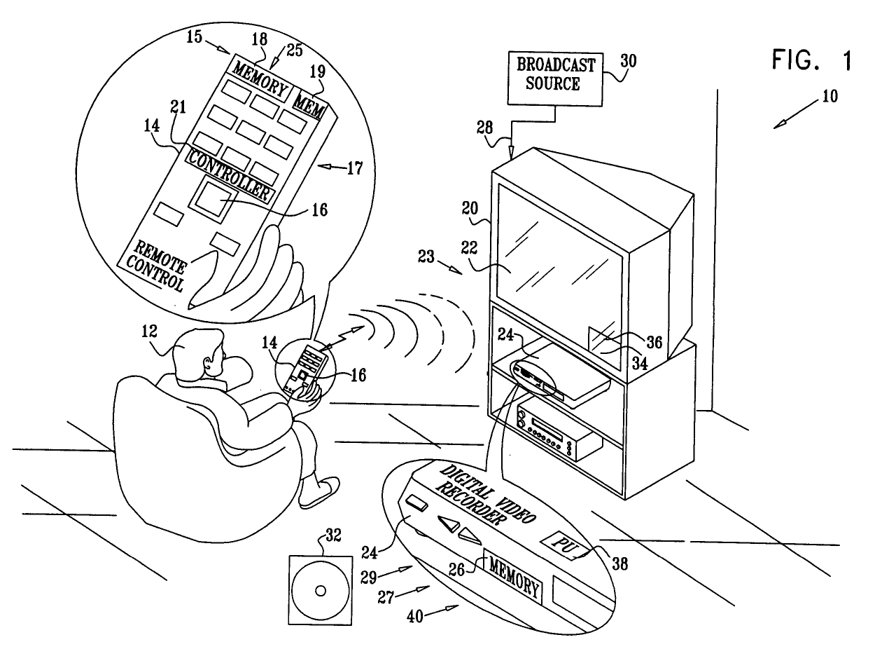

Reference is now made to FIG. 1, which is a schematic illustration of a retrospective replay system 10, according to an embodiment of the present invention. A viewer 12 in system 10 controls a television 20 having a screen 22, the control including selection of a channel the viewer is watching on the screen. Viewer 12 is also hereinbelow termed the primary viewer. Optionally, an inset 34 having a reduced-in-size frame 36 may be displayed on screen 22. The functions of inset 34 and frame 36 are described in more detail below. Parameters under control of viewer 12 include parameters such as volume of the sound and the picture characteristics of the channel. Viewer 12 controls the television using a remote television control 14. Control 14 comprises a wireless communication interface 15 which enables the control to communicate in a bi-directional manner with television 20, typically via a standard wireless communication protocol such as a Bluetooth standard, which may be found at www.bluetooth.com. Optionally, system 10 comprises a non-volatile memory device 32, external to the control, with which control 14 is also able to communicate using the protocol. Device 32 typically comprises a writeable compact disc (CD) or digital video disc (DVD) device; alternatively, device 32 may comprise a mini CD; further alternatively, device 32 may comprise any device having a non-volatile memory which can be written to by control 14 communicating with the device by the wireless protocol.

The channel watched by the viewer is supplied to television 20 from a broadcast source 30, such as a local or national television station. The channel is typically transmitted by a cable television operating system via a cable network 28, although it will be appreciated that any other suitable method of transmission, such as analog and/or digital transmission over-the-air, may be used to provide the channel to television 20.

A digital video recorder (DVR) 24 is coupled to television 20, forming television equipment 23. DVR 24 comprises a processing unit 38. DVR 24 also comprises a fixed non-volatile storage memory 26, typically including one or more disks, in which is stored operating software 40 run by unit 38, so that the combination of PU 38 and software 40 act as a computer. Software 40 may be provided to DVR 24 as a computer software product in a tangible form on a computer-readable medium such as a CD-ROM, or as an electronic data transmission, or as a mixture of both forms. Operations implemented by software 40 are described hereinbelow.

Software 40 enables DVR 24 to store in its memory 26 a record 27 of the channel as it is being watched by viewer 12. Typically, the duration of the record of the channel is of the order of hours, and the total duration of other similar records is of the order of one or more days. Software 40 is further configured so that a most recently viewed section of a broadcast being watched is always stored in memory 26, the duration of the most recently viewed section typically being configurable by viewer 12, and being of the order of 30 minutes. Methods for providing such a configuration are known in the art. Software 40 is also implemented to store a section 29 of the viewed channel in memory 26; section 29 is described in more detail below.

It will be appreciated that the duration of the most recently viewed section, and the total duration of records stored, are functions of a size of memory 26, and typically also of parameters of the memory that viewer 12 may configure, such as an amount of the memory that is reserved for functions other than storing records of viewed channels.

Control 14 comprises a number of controls, typically buttons, including a retrospective capture button 16, which together comprise a user interface 17. Interface 17 communicates with a controller 21 of control 14, enabling viewer 12 to operate the remote control and television equipment 23, and to perform selection of a retrospective section of a broadcast, as described in more detail below. Control 14 also comprises an easily removable, portable non-volatile memory 18, typically a flash-based storage medium such as a Memory Stick produced by Sony Corporation of Tokyo, Japan. Typically, memory 18 may be removed simply by unplugging from a socket 25 in the control. Optionally, control 14 comprises a memory 19, typically a volatile memory such as a random access memory (RAM), which may be permanently installed in the control. The functions of button 16 and memories 18 and 19 are described in more detail below.

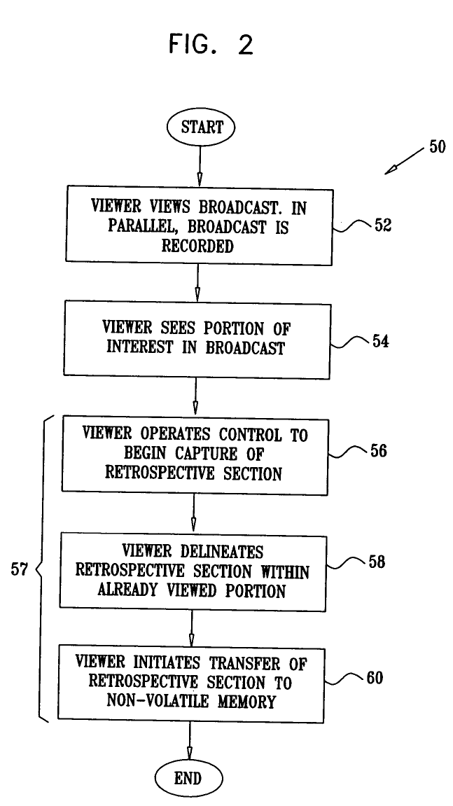

FIG. 2 is a flowchart showing steps of a process 50 performed by viewer 12, according to an embodiment of the a present invention. In an initial step 52, the viewer watches the channel broadcast on screen 20. In parallel the channel is also recorded by DVR 24 in memory 26 during the course of the broadcast. In a second step 54, while watching the channel the viewer sees a portion of interest and decides to save a section 29 of the portion. Thus, after seeing section 29, in a third step 56 the viewer presses button 16 to begin capturing the section. The captured section of the program is herein also termed a retrospective section, and in the specification and in the claims, the term “retrospective section” is to be understood as any section of a television program that has been broadcast and viewed. Section 29 is also referred to hereinbelow as retrospective section 29.

Pressing button 16 initiates a step 58 that allows viewer 12 to delineate, from a portion of the already-viewed channel, parts of the already-viewed channel that are to be included in retrospective section 29. Typically, viewer 12 uses button 16 and other controls of interface 17 to perform the delineation. Typically, software 40 displays inset 34 including reduced-in-size frame 36 on screen 22. Within inset 34 the viewer is able to scroll the display forward and/or backward in time, so as to be able to see all of the previously watched portion, using control 14 to recall into the inset corresponding sections of the viewed channel that have been stored in memory 26. Control 14 is also configured to enable viewer 12 to select one or more parts of the previously viewed portion as retrospective section 29, the selection typically being made by the viewer using the control, via software 40, to place visual markers on the one or more parts in inset 34.

Alternatively, inset 34 displays a multiplicity of snapshots of frames 36 that have been previously watched, each snapshot representing an interval of viewed time. Viewer 12 uses control 14 to choose which intervals of viewed time are to be incorporated in retrospective section 29, typically by placing visual markers on the snapshots. Other methods for selecting one or more parts of a previously viewed portion of a channel, while continuing to watch the channel, will be apparent to those skilled in the art; all such methods are assumed to be included within the scope of the present invention. Whichever method is used, retrospective section 29 is temporarily stored in memory 26.

In a final step 60, after retrospective section 29 has been selected in step 58, the viewer uses control 14 to issue instructions for copying of the retrospective section from memory 26 to another non-volatile memory. In an embodiment of the present invention, the non-volatile memory comprises memory 18. The copying is performed via the wireless communication protocol with which control 14 and television 20 communicate.

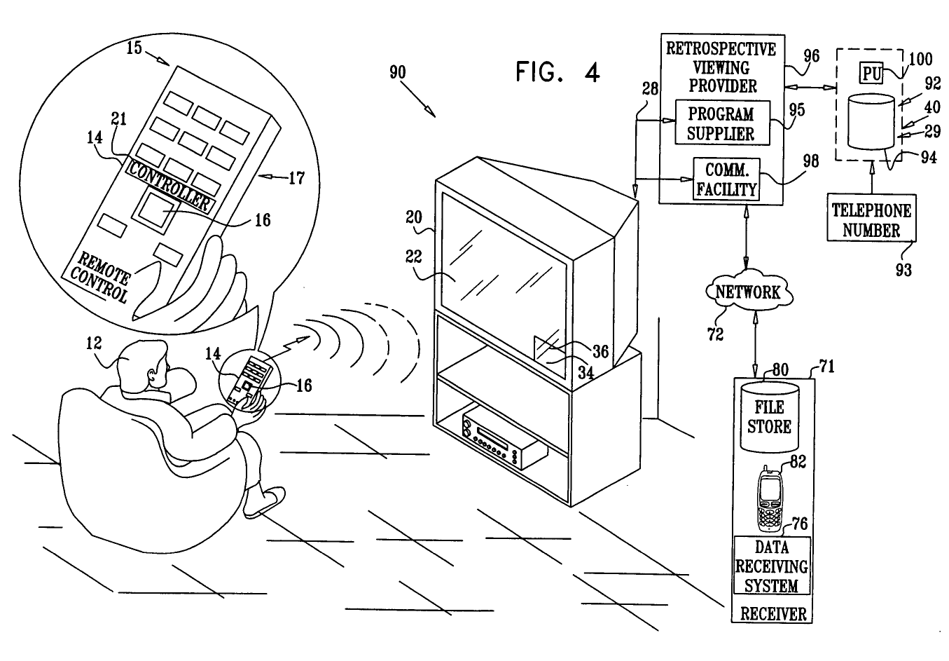

In one embodiment of the present invention, described in more detail with reference to FIG. 4 below, steps 56, 58, and 60 are replaced by a step 57.

In an example embodiment of the present invention, remote control 14 uses memory 19, rather than memory 18, to implement storage of retrospective section 29 in a device that is remote from the control. In this embodiment, control 14 also communicates via its wireless protocol with non-volatile memory device 32. In final step 60, rather than writing retrospective section 29 to memory 18, remote control 14 acts as a relay by reading the retrospective section from memory 26 into memory 19, and transferring the retrospective section from memory 19 to device 32. The relaying of retrospection section 29 from memory 26 to device 32 is typically performed as a batch process.

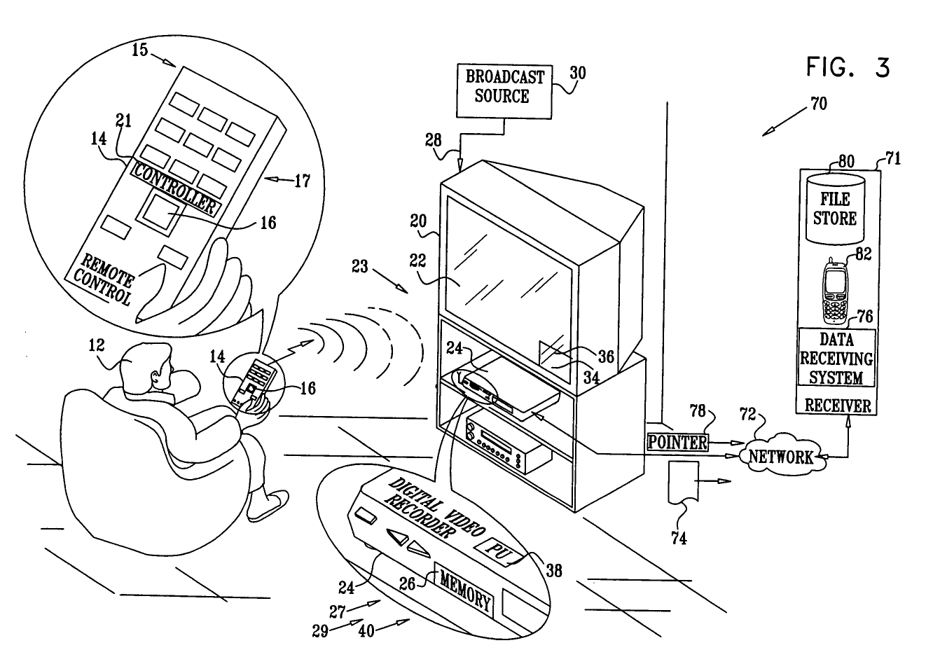

FIG. 3 is a schematic illustration of an alternative retrospective replay system 70, according to an embodiment of the present invention. Apart from the differences described below, the operation of system 70 is generally similar to that of system 10 (FIG. 1), such that elements indicated by the same reference numerals in both systems 70 and 10 are generally identical in construction and in operation. Unlike system 10, in system 70 control 14 typically does not use memory 18 or memory 19. Optionally, button 16 is located on DVR 24, so that viewer 12 may invoke process 50 (FIG. 2) without the use of control 14. Unless otherwise stated, hereinbelow it is assumed that viewer 12 uses control 14 in operating system 70 and to invoke process 50. In system 70, DVR 24 is coupled to a data network 72 such as the Internet by either a wired or a wireless coupling. DVR 24 communicates with network 72 using processing unit 38 and software 40, which in system 70 is also configured as communication software.

Data network 72 and software 40 enable DVR 24 to communicate with a data receiver 71, which is typically remote from the DVR. Data receiver 71 typically comprises a file store 80, typically one or more disks wherein data may be stored permanently, a cellular telephone 82, and/or a data receiving system 76. Data receiver 71 may typically be controlled by viewer 12 (the primary viewer) independently of the control the viewer has of television 20. Alternatively or additionally, at least part of receiver 12 may be under the control of a person, herein also termed the secondary viewer, other than the primary viewer. For example, if receiver 71 comprises telephone 82, the telephone may belong to, and have a number identified with, either the primary viewer or the secondary viewer. Data receiving system 76 typically comprises any suitable system which is able to receive data, such as a terminal which is coupled to receive electronic mail (email) via network 72, or a computer which is able to send and receive data and/or files via the network using a protocol such as a file transfer protocol.

In system 70, viewer 12 performs process 50 (FIG. 2) to form retrospective section 29. However, rather than transferring retrospective section 29, as delineated in step 58, to a memory local to control 14, viewer 12 implements step 60 of process 50 by transferring the retrospective section, and/or a pointer 78 to the retrospective section, to receiver 71. Pointer 78 typically comprises a Uniform Resource Locator (URL) and/or a file address. In the case of transfer of the retrospective section, it is typically transferred as one or more files 74.

Software 40 is configured to facilitate the transfer to receiver 71, by enabling viewer 12 to enter relevant identifying parameters of the receiver. Such identifying parameters typically include one or more of a URL of store 80, a telephone number of telephone 82, and/or an email or other address of system 76. Software 40 is also configured to enable viewer 12 to choose which data, i.e., the retrospective section and/or pointer 78, is to be transferred to receiver 71. It will be understood that viewer 12 may thus have a number of options for transfer of the retrospective section and/or the pointer.

For example, viewer 12 may choose to send delineated retrospective section 29 directly to telephone 82, in which case software 40 enables the viewer to input a telephone number of the telephone. Alternatively, viewer 12 may send the retrospective section to file store 80, and may also send pointer 78, as an address of the stored file, to an email address comprised in system 76. Further alternatively, viewer 12 may send retrospective section 29 directly as one or more files 74 to a computer comprised in system 76. Other combinations and sub-combinations of options for transfer of retrospective section 29 and/or pointer 78 will be apparent to those skilled in the art; all such combinations and sub-combinations are assumed to be comprised within the scope of the present invention.

It will be understood that viewer 12 may implement the options available via control 14. In this case software 40 typically generates an interactive dialog within inset 34, the interactive dialog being configured according to the option or options used by viewer 12, and so that the viewer is able to effect the interaction with the dialog using control 14. Typically, the interaction takes the form of viewer 12 entering an address or a telephone number of the destination of retrospective section 29 and/or pointer 78.

FIG. 4 is a schematic illustration of a further alternative retrospective replay system 90, according to an embodiment of the present invention. Apart from the differences described below, the operation of system 90 is generally similar to that of system 70 (FIG. 3), such that elements indicated by the same reference numerals in both systems 70 and 90 are generally identical in construction and in operation. In an alternative embodiment of system 90, button 16 is located on DVR 24, so that viewer 12 may invoke process 50 (FIG. 2) without the use of control 14. Unless otherwise stated, it is assumed that viewer 12 uses control 14 in operating system 90 and to invoke process 50.

Unlike systems 10 and 70, in system 90 a retrospective viewing provider 96 maintains in a non-volatile memory 94 a record 92 of the channel being viewed by viewer 12, record 92 being generally similar to record 27 described above. Provider 96 uses a processing unit 100 which operates software 40 stored in memory 94. Provider 96 may comprise a program supplier 95, such as broadcast source 30, in which case provider 96 also broadcasts the channel being viewed. Alternatively or additionally, provider 96 may comprise a communication facility 98, such as a telephone company, which maintains record 92 and is coupled to cable network 28, but does not broadcast the channel. Provider 96 is coupled to data network 72, and maintains communication with the network via software 40.

In system 90, control 14 is implemented to have bi-directional communication with provider 96 using button 16. The communication is via a local wireless communication protocol, such as the Bluetooth standard referenced above, between the control and television 20, in series with a different protocol, able to provide communications between television 20 and the provider, such as an Ethernet protocol.

In the case that provider 96 comprises program supplier 95, and so broadcasts the channel being viewed, button 16 enables viewer 12 to perform steps 56, 58, and 60 of process 50 (FIG. 2), substantially as described above for system 70. Thus, retrospective section 29 is stored in memory 94, and the retrospective section may be transferred from provider 96 to network 72 as one or more files 74. Alternatively or additionally, pointer 78 may be transferred from provider 96 to network 72. (For reasons of clarity, neither files 74 nor pointer 78 are shown in FIG. 4). It will thus be understood that when provider 96 comprises the program supplier, provider 96 performs substantially similar functions as does DVR 24 in system 70, and the options as described above with reference to system 70 are available to viewer 12 in system 90.

In the case that provider 96 does not comprise program supplier 95, and so does not broadcast the channel, steps 56, 58, and 60 are replaced by step 57 (FIG. 2). Step 57 is implemented by viewer 12 pressing button 16. Step 57 automatically saves, at provider 96, a pre-determined already-viewed period of the broadcast channel as retrospective section 29. Step 57 also implements a pre-determined option, selected from one of the number of options described above with reference to system 70, for transfer of retrospective section 29 and/or pointer 78.

Alternatively, step 57 comprises storing the retrospective section as a file in memory 94, and generating and storing in memory 94 a telephone number 93, typically a temporary number, associated with the file. Step 57 typically comprises forwarding the telephone number to viewer 12 by any method known in the art, such as via a short messaging system message to a telephone number of the viewer. Viewer 12 may then provide the telephone number to a friend or other acquaintance of the primary viewer, who are able to view the retrospective section by dialing the number.

It will be appreciated that in system 90 provider 96 may be recording a number of channels being transmitted over cable network 28 to television 20, one of these channels comprising the retrospective section required by viewer 12. Furthermore, viewer 12 may be able to watch more than one of the channels received at television 20, for example using a split screen showing two or more channels simultaneously. In this case, user interface 17 of control 14 typically comprises controls which enable viewer 12 to notify provider 96 which specific channel is to be used to form the retrospective section.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention. Methods may be implemented as signal methods employing signals to implement one or more steps. Signals include those emanating from the Internet, etc.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. A method for recording a television broadcast, comprising:
generating a record of the television broadcast;
while viewing the television broadcast, operating a television remote control to select from the record a retrospective section of the record; and
storing the retrospective section in the television remote control.

2. The method according to claim 1, wherein the step of storing the retrospective section comprises providing a non-volatile memory in the remote control.

3. The method according to claim 2, wherein the non-volatile memory comprises a removable memory.

4. The method according to claim 1, wherein the step of generating the record comprises storing the record in a digital video recorder, wherein viewing the television broadcast comprises viewing the broadcast on a television receiving the broadcast, and wherein operating the television remote control comprises communicating with the DVR and the television via the control.

5. A method for recording a television broadcast, comprising:
generating a record of the television broadcast at a retrospective viewing provider;
operating a television remote control to communicate over a network with the provider so as to select from the record, while viewing the television broadcast on a television remote from the provider, a retrospective section of the record; and
operating the television remote control to transfer from the provider to a receiver at least one of a pointer to the retrospective section and the retrospective section.

6. The method according to claim 5, wherein the step of operating the television remote control comprises implementing the remote control to communicate with the television via a first communication protocol, and implementing the television to communicate with the retrospective viewing provider over the network via a second communication protocol, different from the first protocol.

7. The method according to claim 5, wherein the receiver comprises at least one of: a file storage system, a cellular telephone, and a data receiving system.

8. The method according to claim 5, wherein the pointer comprises at least one of: a telephone number, a file address, and a uniform resource locator (URL).

9. The method according to claim 5, wherein the television broadcast being viewed is chosen from a plurality of broadcast channels, and wherein operating the television remote control to communicate with the provider comprises informing the provider of the broadcast channel corresponding to the television broadcast being viewed.

10. A method for recording a television broadcast, comprising:
generating a record of the television broadcast; and
operating a television remote control to select from the record, while viewing the television broadcast, a retrospective section of the record and to relay, via a first memory comprised in the remote control, the retrospective section to a second memory separate from the remote control.

11. The method according to claim 10, wherein generating the record comprises generating the record in a digital video recorder which communicates with the remote control via a wireless communication protocol, wherein the second memory comprises a non-volatile memory which communicates with the remote control via the wireless communication protocol, and wherein the first memory comprises a volatile memory.

12. A television remote control, comprising:
a memory;
a wireless communication interface, for communicating with television equipment;
a user interface, which enables a viewer of a broadcast displayed by the television equipment to control functions of the remote control and of the television equipment via the communication interface; and
a controller, which is adapted, under control of the viewer via the user interface, to select a retrospective section of the television broadcast, to receive the retrospective section from the television equipment over the wireless communication interface, and to store the retrospective section in the memory.

13. The control according to claim 12, wherein the memory comprises a non-volatile memory which is removable from the control.

14. Television apparatus, comprising:
a television monitor which displays a television broadcast;
a digital video recorder which records the broadcast;
a television remote control comprising a memory, the remote control communicating with the DVR and the monitor via a wireless communication interface, and being adapted to select a retrospective section of the television broadcast, to receive the retrospective section from the DVR over the wireless communication interface, and to store the retrospective section in the memory.

15. The apparatus according to claim 14, wherein the memory comprises a non-volatile removable memory.

16. A computer software product for recording a television broadcast, comprising a computer-readable medium having computer program instructions recorded therein, which instructions, when read by a computer, cause the computer to:
generate a record of the television broadcast at a retrospective viewing provider,
select, in response to an indication generated with a television control by a viewer of the broadcast displayed on a television and communicated over a network to the provider, a retrospective section of the record, and
transfer from the provider to a receiver, in response to the indication at least one of: a pointer to the retrospective section, and the retrospective section.

17. The product according to claim 16, wherein the pointer comprises at least one of: a telephone number, a file address, and a uniform resource locator.

18. The product according to claim 16, wherein the receiver comprises at least one of: a file storage system, a cellular telephone, and a data receiving system.

19. A method for recording a television broadcast, comprising:
generating a record of the television broadcast in television equipment; and
operating a television remote control to select from the record, while viewing the television broadcast on the television equipment, a retrospective section of the record, and to convey at least one of the retrospective section and a pointer to the retrospective section, to a receiver separate from the remote control and the television equipment.

20. The method according to claim 1, wherein:
the step of storing the retrospective section comprises providing a non-volatile memory in the remote control;
the non-volatile memory comprises a removable memory; and
the step of generating the record comprises storing the record in a digital video recorder, wherein viewing the television broadcast comprises viewing the broadcast on a television receiving the broadcast, and wherein operating the television remote control comprises communicating with the DVR and the television via the control.
